(19) United States
(12) Patent Application Publication
(10) Pub. No.: US 2025/0113233 A1
(43) Pub. Date: Apr. 3, 2025

(54) COMMUNICATION METHOD AND APPARATUS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/833,202

(22) PCT Filed: Jan. 28, 2022
(86) PCT No.: PCT/CN2022/074835

§ 371 Date: Jul. 25, 2024

(51) Int. Cl. H04W 24/10; H04L 5/00; H04W 4/38; H04W 76/18

(52) U.S. Cl. CPC H04W 24/10; H04L 5/0053; H04W 76/18; H04W 4/38

(57) ABSTRACT

A communication method includes: sending a first radio frame, wherein the first radio frame includes first time information, the first time information indicates timeout time information for a proxy access point (AP) to provide feedback on a sensing measurement result, and the sensing measurement result includes a measurement result of a wireless local area network (WLAN) sensing measurement established by the proxy AP, as a proxy for a sensing initiator.

### CROSS-REFERENCE TO RELATED APPLICATIONS

The present disclosure is the U.S. national phase application of International Application No. PCT/CN2022/074835 filed on Jan. 28, 2022, the content of which is incorporated herein by reference in its entirety for all purposes.

### TECHNICAL FIELD

The present disclosure relates to the field of mobile communication technology, in particular to a communication method, a communication apparatus, an electronic device, and a storage medium.

### BACKGROUND

Wireless Fidelity (Wi-Fi) technology has made tremendous progress in transmission speed and throughput, with the rapid development of mobile communication technology. At present, the research on Wi-Fi technology includes, for example, 320 MHz bandwidth transmission, aggregation and collaboration of multiple frequency bands, etc. Main application scenarios include, for example, video transmission, augmented reality (AR), virtual reality (VR), etc.

Among the Wi-Fi technologies currently being studied, the wireless local area network (WLAN) sensing technology may be supported, and some application scenarios are, for example, location discovery, proximity detection, and presence detection in dense environments such as home and business environments.

### SUMMARY

In one aspect, the present disclosure provides a communication method, performed by an initiator, and the method includes: sending a first radio frame, wherein the first radio frame includes first time information, the first time information indicates timeout time information for a proxy access point (AP) to provide feedback on a sensing measurement result, and the sensing measurement result includes a measurement result of a wireless local area network (WLAN) sensing measurement established by the proxy AP acting as a proxy for the initiator.

In another aspect, the present disclosure provides a communication method, performed by a proxy access point (AP), and the method includes: receiving a first radio frame, wherein the first radio frame includes first time information, the first time information indicates the timeout time information for the proxy AP to provide feedback on a sensing measurement result, and the sensing measurement result includes a measurement result of a wireless local area network (WLAN) sensing measurement established by the proxy AP acting as a proxy for an initiator.

In another aspect, the present disclosure provides an initiator, and the initiator includes: a sensing module configured to send a first radio frame, wherein the first radio frame includes first time information, the first time information indicates timeout time information for a proxy access point (AP) to provide feedback on a sensing measurement result, and the sensing measurement result includes a measurement result of a wireless local area network (WLAN) sensing measurement established by the proxy AP acting as a proxy for the initiator.

In another aspect, the present disclosure provides an access point (AP), and the access point includes: a receiving module configured to receive a first radio frame, wherein the first radio frame includes first time information, the first time information indicates the timeout time information for the proxy AP to provide feedback on a sensing measurement result, and the sensing measurement result includes a measurement result of a wireless local area network (WLAN) sensing measurement established by the proxy AP acting as a proxy for an initiator.

In another aspect, the present disclosure provides a communication apparatus, applied to an initiator, and the apparatus includes: a radio frame sensing module configured to send a first radio frame, wherein the first radio frame includes first time information, the first time information indicates timeout time information for a proxy access point (AP) to provide feedback on a sensing measurement result, and the sensing measurement result includes a measurement result of a wireless local area network (WLAN) sensing measurement established by the proxy AP acting as a proxy for the initiator.

In another aspect, the present disclosure provides a communication apparatus, applied to an access point (AP), and the apparatus includes: a radio frame receiving module configured to receive a first radio frame, wherein the first radio frame includes first time information, the first time information indicates the timeout time information for a proxy AP to provide feedback on a sensing measurement result, and the sensing measurement result includes a measurement result of a wireless local area network (WLAN) sensing measurement established by the proxy AP acting as a proxy for an initiator.

The present disclosure also provides an electronic device including a memory, a processor, and a computer program stored on the memory and capable of running on the processor. When the processor executes the computer program, one or more methods as described in embodiments of the present disclosure are caused to be implemented.

The present disclosure also provides a computer-readable storage medium on which a computer program is stored. When the computer program is executed by a processor, one or more methods as described in embodiments of the present disclosure are caused to be implemented.

The additional aspects and advantages of embodiments of the present disclosure will be partially provided in the following description, which will become apparent from the following description or will be understood through practice of the present disclosure.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is a flowchart of a communication method according to embodiments of the present disclosure;

FIG. 2 is a schematic diagram of an architecture of the WLAN sensing according to embodiments of the present disclosure;

FIG. 3 is a schematic diagram of an architecture of the WLAN sensing according to embodiments of the present disclosure;

FIG. 4 is a schematic diagram of an architecture of the WLAN sensing according to embodiments of the present disclosure;

FIG. 5 is a flowchart of a communication method according to embodiments of the present disclosure;

FIG. 6 is a flowchart of a communication method according to embodiments of the present disclosure;

FIG. 7 is a flowchart of a communication method according to embodiments of the present disclosure;

FIG. 8 is a schematic structural diagram of an initiator according to embodiments of the present disclosure;

FIG. 9 is a schematic structural diagram of an access point according to embodiments of the present disclosure; and

FIG. 10 is a schematic structural diagram of an electronic device according to embodiments of the present disclosure.

### DETAILED DESCRIPTION

The term “and/or” in embodiments of the present disclosure describes the association relationship between associated objects, indicating that there can be three kinds of relationships. A and/or B, for example, can indicate the presence of A alone, the presence of A and B simultaneously, and the presence of B alone. The character “/” generally indicates that associated objects have an “or” relationship between them.

The term “multiple” in embodiments of the present disclosure refers to two or more, other quantifiers are similar to this.

A detailed explanation of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of the present disclosure as detailed in the appended claims.

The terms used in embodiments of the present disclosure are for the purpose of description of specific embodiments only, and are not intended to limit the embodiments of the present disclosure. Singular forms such as “a”, “said”, and “the” used in embodiments of the present disclosure and the appended claims are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information about the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

A clear and complete description of technical solutions disclosed in the embodiments of the present disclosure will be provided in the following, in conjunction with the drawings. Obviously, the embodiments described are only a part of disclosed embodiments of the present disclosure and not all of them. Based on the embodiments of the present disclosure, all other embodiments obtained by those of ordinary skill in the art without creative efforts fall within the protection scope of the present disclosure.

In the process of the WLAN sensing, the identities of a station (STA) and an access point (AP) can usually be exchanged. For example, the STA and the AP can both serve as sensing initiators or sensing transmitters. When serving as a sensing initiator or a sensing transmitter, the AP can communicate with multiple STAs simultaneously, but the STA does not have such functionality and can only communicate with a single responder (sensing responder) in one-to-one manner, which not only wastes spectrum resources, but also increases latency. For those communication scenarios where latency is critical, it may not be able to meet the latency requirements. To address this issue, an optional WLAN sensing process has been proposed, where the AP performs the WLAN sensing measurement on behalf of the STA. After performing the WLAN sensing measurement on behalf of the STA, the AP needs to provide feedback on the measurement results to the STA. Therefore, it is necessary to propose a method for AP to provide feedback on measurement results to STA.

Embodiments of the present disclosure provide a communication method, a communication apparatus, an electronic device, and a storage medium, which propose a method for providing feedback on measurement results to STA in a scenario where the AP, acting as a proxy for the STA, performs the WLAN sensing measurement.

In some embodiments, the method and the apparatus are based on the same inventive concept. Due to the similar principles of solving problems by the method and by the apparatus, reference can be made between embodiments of the apparatus and the method, and the same will not be repeated.

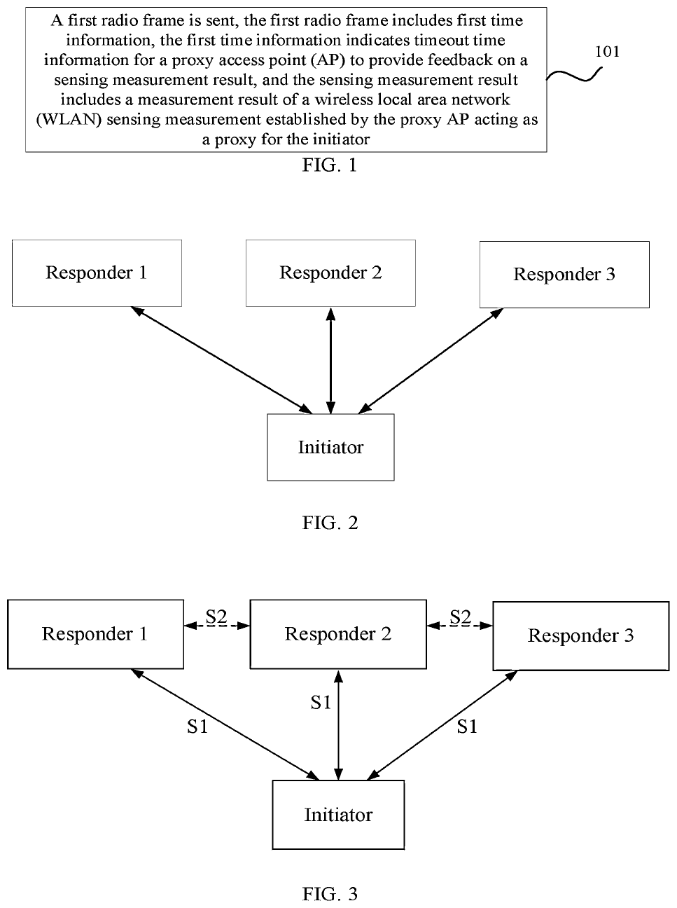

As shown in FIG. 1, embodiments of the present disclosure provide a communication method, which is performed by an initiator. In some embodiments, the initiator can be an STA. For ease of explanation, a requesting STA will be used in the following to represent the initiator. It can be understood that this does not constitute a limitation on embodiments of the present disclosure.

The method provided in embodiments of the present disclosure can include the following steps.

In step 101, a first radio frame is sent, and the first radio frame includes first time information. The first time information indicates timeout time information for a proxy access point (AP) to provide feedback on a sensing measurement result. The sensing measurement result includes a measurement result of a wireless local area network (WLAN) sensing measurement established by the proxy AP acting as a proxy for the initiator.

Reference is made to FIGS. 2 to 4, and the WLAN sensing architecture and the WLAN sensing process to which the communication method provided in embodiments of the present disclosure is applied are first introduced.

FIG. 2 shows a schematic diagram of an architecture of the WLAN sensing (process). In some embodiments, when a sensing initiator (or an initiator, i.e., a requesting STA) initiates the WLAN sensing (e.g., initiating a WLAN sensing session), multiple sensing responders (or sensing receivers) or responders may respond to the WLAN sensing, as is shown by Responder 1, Responder 2, and Responder 3 in FIG. 2. When the sensing initiator initiates the WLAN sensing, multiple sensing responders associated or not associated with the WLAN sensing can respond.

As shown in FIG. 3, the sensing initiator communicates with the sensing responder through a link, as shown by a link S1, and the communication between the sensing responders is carried out through a link S2.

In some embodiments, each sensing initiator can be a client, and each sensing responder (for example, the sensing Responder 1 to the sensing Responder 3) can be a station (STA) or an access point (AP). The STA and the AP can assume multiple roles in the WLAN sensing process. For example, in the WLAN sensing process, the STA can also serve as the sensing initiator, and the sensing initiator may be a sensing transmitter, a sensing receiver, or both, or neither. In the WLAN sensing process, the sensing responder may also be a sensing transmitter, a sensing receiver, or both.

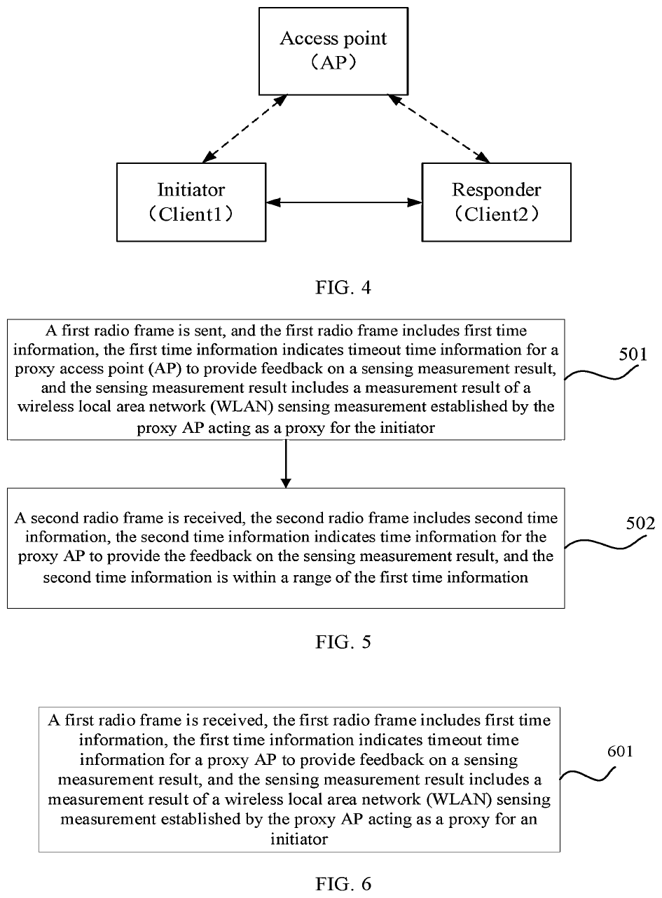

Another architecture is shown in FIG. 4, the sensing initiator and the sensing responder can be both clients, and the two can be connected to the same AP for communication. In FIG. 4, Client 1 is the sensing initiator and Client 2 is the sensing responder.

Usually, when serving as a sensing initiator or a sensing transmitter, the STA does not have the ability to communicate with multiple receivers simultaneously, and thus a proxy device (such as an AP) is needed to perform the sensing measurement for the STA. In the scenario where the AP, acting as a proxy for the requesting STA (i.e., the STA that requests the AP to perform the sensing measurement on its behalf), performs the sensing measurement, the STA sends the first radio frame, and the time when the AP provides the feedback on the measurement result to the STA is indicated in the first radio frame. That is, in the first radio frame, the time when the requesting STA receives the sensing results is indicated. The first radio frame can be a sensing by proxy (SBP) requesting frame, or the first radio frame can be a message frame configured to negotiate with the AP during an establishment of the sensing measurement.

In some embodiments, the first radio frame includes the first time information. The first time information indicates the timeout time information for the proxy access point (AP) to provide the feedback on the sensing measurement result. The sensing measurement result includes the measurement result of the wireless local area network (WLAN) sensing measurement established by the proxy AP acting as a proxy for the initiator. In some embodiments, the timeout time information can be either a timeout interval element (TIE) or a timeout element. The first time information indicates that after completing the proxy sensing measurement, the proxy AP will provide the feedback on the sensing measurement result to the requesting STA within the time indicated by the first time information, so as to meet the latency requirements of the requesting STA and improve the WLAN sensing measurement process.

In some embodiments of the present disclosure, the initiator sends the first radio frame, and the first radio frame carries the first time information, which indicates the timeout time information for the proxy AP to provide the feedback on the sensing measurement result. Embodiments of the present disclosure propose a method for providing the feedback on the measurement result in a scenario where the AP, acting as a proxy for the STA, performs the WLAN sensing measurement.

In some embodiments, the first time information includes latency information for the proxy AP to establish the WLAN sensing measurement, or the timeout time information for the proxy AP to provide the feedback on the sensing measurement result. The latency information is, for example, the TIE element, which can be carried by the requesting STA in the process of establishing the proxy sensing measurement with the proxy AP. The frame format of the TIE element is shown in Table 1 below.

TABLE 1

| | | | Timeout | Timeout |
|---|---|---|---|---|
| Information | | | Interval | Interval |
| Content | Element ID | Length | Type | Value |
| Octets | 1 | 1 | 1 | 4 |

In Table 1, the TIE element includes four sub-elements, with Element ID, Length, and Timeout Interval Type each occupying one byte, and Timeout Interval Value occupying four bytes.

In some embodiments, the field Timeout Interval Type indicates the type of the timeout interval, and the field Timeout Interval Value indicates the value of the timeout interval. When the field Timeout Interval Type indicates that the type is the first time information (or the time information for the requesting STA to receive the feedback result), the field Timeout Interval Value indicates the specific time of the first time information, in time unit (TU).

As shown in Table 2, the meanings of different values of the Timeout Interval Type are as follows.

TABLE 2

| Timeout Interval | | |
|---|---|---|
| Type | Meaning | Units |
| 0 | Reserved | Time Unit (TUs) |
| 1 | Reassociation deadline interval | Time Unit (TUs) |
| 2 | Key lifetime interval | Seconds |
| 3 | Association comeback time | Time Unit (TUs) |
| 4 | Time-to-Start | Time Unit (TUs) |
| 5-255 | Reserved | Time Unit (TUs) |

For example, taking the Timeout Interval Type of 1 as an example, it indicates the reassociation deadline interval. The values of the field Timeout Interval Type of 5 to 255 are reserved currently, and one of the values can be selected to indicate the first time information. For example, 5 is selected to identify the first time information.

As shown in FIG. 5, embodiments of the present disclosure provide a communication method, which is performed by an initiator. In some embodiments, the initiator can be an STA. For ease of explanation, a requesting STA will be used in the following to represent the initiator. The method can include the following steps.

In step 501, a first radio frame is sent, and the first radio frame includes first time information. The first time information indicates timeout time information for a proxy access point (AP) to provide feedback on a sensing measurement result. The sensing measurement result includes a measurement result of a wireless local area network (WLAN) sensing measurement established by the proxy AP acting as a proxy for the initiator.

In the scenario where the AP, acting as a proxy for the requesting STA (i.e., the STA that requests the AP to perform the sensing measurement on its behalf), performs the sensing measurement, the STA sends the first radio frame, and the time when the AP provides the feedback on the measurement result to the STA is indicated in the first radio frame. That is, in the first radio frame, the time when the requesting STA receives the sensing results is indicated. The first radio frame can be a sensing by proxy (SBP) requesting frame, or the first radio frame can be a message frame configured to negotiate with the AP during an establishment of the sensing measurement.

In some embodiments, the first radio frame includes the first time information. The first time information indicates the timeout time information for the proxy access point (AP) to provide the feedback on the sensing measurement result. The sensing measurement result includes the measurement result of the wireless local area network (WLAN) sensing measurement established by the proxy AP acting as a proxy for the initiator. The first time information indicates that after completing the proxy sensing measurement, the AP will provide the feedback on the sensing measurement result to the requesting STA within the time indicated by the first time information.

In step 502, a second radio frame is received, and the second radio frame includes second time information. The second time information indicates time information for the proxy AP to provide the feedback on the sensing measurement result, and a time range indicated by the second time information is within a time range indicated by the first time information.

In some embodiments, the second radio frame can be an SBP response frame. The proxy AP carries, based on the first time information, the second time information in the second radio frame that is replied to the requesting STA. The second time information indicates the time information for the proxy AP to provide the feedback on the sensing measurement result. In some embodiments, the time range indicated by the second time information is within the time range indicated by the first time information. That is, the proxy AP provides the feedback on the sensing measurement result within the time specified by the requesting STA, so as to meet the latency requirements of the requesting STA and improve the WLAN sensing measurement process.

In some embodiments of the present disclosure, the second time information includes at least one of time instant information or time segment information. The time instant information refers to time point information. For example, the proxy AP immediately provides the feedback on the sensing measurement result after receiving the first radio frame. The time segment information refers to time period information. For example, the proxy AP provides the feedback on the sensing measurement result within a time period after receiving the first radio frame.

In some embodiments of the present disclosure, in the absence of a link between the initiator and the proxy AP, the second radio frame further includes time synchronization function (TSF) parameter information of the proxy AP. That is, if the requesting STA does not establish an initial association (i.e., a link) with the proxy AP, the second radio frame further includes the time synchronization function (TSF) parameter information of the proxy AP, so that the requesting STA can keep time synchronization with the proxy AP.

In some embodiments, the first radio frame includes a sensing by proxy (SBP) requesting frame or a sensing message frame. For example, if the requesting STA participates in the sensing measurement, the requesting STA will carry the first time information in the sensing by proxy (SBP) requesting frame.

If the requesting STA does not participate in the sensing measurement, the requesting STA will carry the first time information in the sensing message frame. The sensing message frame includes a message frame during the establishment of the WLAN sensing measurement by the proxy AP acting as a proxy for the initiator.

In some embodiments of the present disclosure, the initiator sends the first radio frame, so as to carry the first time information in the first radio frame. The first time information indicates the timeout time information for the proxy AP to provide the feedback on the sensing measurement result. Embodiments of the present disclosure propose a method for providing the feedback on the measurement result in a scenario where the AP, acting as a proxy for the STA, performs the WLAN sensing measurement.

As shown in FIG. 6, embodiments of the present disclosure also provide a communication method, which is performed by a proxy access point (AP). The method can include the following steps.

In step 601, a first radio frame is received, and the first radio frame includes first time information. The first time information indicates timeout time information for a proxy AP to provide feedback on a sensing measurement result. The sensing measurement result includes a measurement result of a wireless local area network (WLAN) sensing measurement established by the proxy AP acting as a proxy for an initiator.

Reference is made to FIGS. 2 to 4, and the WLAN sensing architecture and the WLAN sensing process to which the communication method provided in embodiments of the present disclosure is applied are first introduced. The specific contents can be found in the aforementioned embodiments and will not be repeated here.

Usually, when serving as a sensing initiator or a sensing transmitter, the STA does not have the ability to communicate with multiple receivers simultaneously, and thus a proxy device (such as an AP) is needed to perform the sensing measurement for the STA. In the scenario where the AP, acting as a proxy for the requesting STA (i.e., the STA that requests the AP to perform the sensing measurement on its behalf), performs the sensing measurement, the AP receives the first radio frame sent by the STA, and the time when the AP provides the feedback on the measurement result to the STA is indicated in the first radio frame. That is, in the first radio frame, the time when the requesting STA receives the sensing results is indicated. The first radio frame can be a sensing by proxy (SBP) requesting frame, or the first radio frame can be a message frame configured to negotiate with the AP during an establishment of the sensing measurement.

In some embodiments, the first radio frame includes the first time information. The first time information indicates the timeout time information for the proxy access point (AP) to provide the feedback on the sensing measurement result. The sensing measurement result includes the measurement result of the wireless local area network (WLAN) sensing measurement established by the proxy AP acting as a proxy for the initiator. In some embodiments, the timeout time information can be either a timeout interval element (TIE) or a timeout element. After completing the proxy sensing measurement, the proxy AP will provide the feedback on the sensing measurement result to the requesting STA within the time indicated by the first time information, so as to meet the latency requirements of the requesting STA and improve the WLAN sensing measurement process.

In some embodiments of the present disclosure, the proxy AP receives the first radio frame and obtains the first time information carried in the first radio frame, which indicates the timeout time information for the proxy AP to provide the feedback on the sensing measurement result. Embodiments of the present disclosure propose a method for providing the feedback on the measurement result in a scenario where the AP, acting as a proxy for the STA, performs the WLAN sensing measurement.

In some embodiments, the first time information includes latency information for the proxy AP to establish the WLAN sensing measurement, or the timeout time information for the proxy AP to provide the feedback on the sensing measurement result. The latency information is, for example, the TIE element, which can be carried by the requesting STA in the process of establishing the proxy sensing measurement with the proxy AP. The frame format of the TIE element is shown in Table 1 below.

TABLE 1

| | | | Timeout | Timeout |
|---|---|---|---|---|
| Information | | | Interval | Interval |
| Content | Element ID | Length | Type | Value |
| Octets | 1 | 1 | 1 | 4 |

In Table 1, the TIE element includes four sub-elements, with Element ID, Length, and Timeout Interval Type each occupying one byte, and Timeout Interval Value occupying four bytes.

In some embodiments, the field Timeout Interval Type indicates the type of the timeout interval, and the field Timeout Interval Value indicates the value of the timeout interval. When the field Timeout Interval Type indicates that the type is the first time information (or the time information for the requesting STA to receive the feedback result), the field Timeout Interval Value indicates the specific time of the first time information, in time unit (TU).

As shown in Table 2, the meanings of different values of the Timeout Interval Type are as follows.

TABLE 2

| Timeout Interval | | |
|---|---|---|
| Type | Meaning | Units |
| 0 | Reserved | Time Unit (TUs) |
| 1 | Reassociation deadline interval | Time Unit (TUs) |
| 2 | Key lifetime interval | Seconds |
| 3 | Association comeback time | Time Unit (TUs) |
| 4 | Time-to-Start | Time Unit (TUs) |
| 5-255 | Reserved | Time Unit (TUs) |

For example, taking the Timeout Interval Type of 1 as an example, it indicates the reassociation deadline interval. The values of the field Timeout Interval Type of 5 to 255 are reserved currently, and one of the values can be selected to indicate the first time information. For example, 5 is selected to identify the first time information.

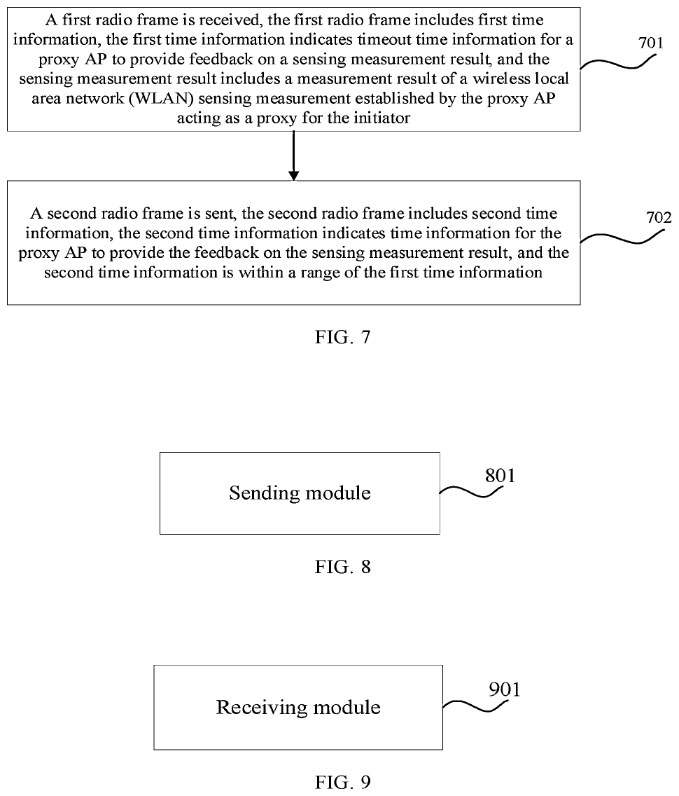

As shown in FIG. 7, embodiments of the present disclosure also provide a communication method, which is performed by a proxy access point (AP). The method can include the following steps.

In step 701, a first radio frame is received, and the first radio frame includes first time information. The first time information indicates timeout time information for a proxy AP to provide feedback on a sensing measurement result. The sensing measurement result includes a measurement result of a wireless local area network (WLAN) sensing measurement established by the proxy AP acting as a proxy for the initiator.

Usually, when serving as a sensing initiator or a sensing transmitter, the STA does not have the ability to communicate with multiple receivers simultaneously, and thus a proxy device (such as an AP) is needed to perform the sensing measurement for the STA. In the scenario where the AP, acting as a proxy for the requesting STA (i.e., the STA that requests the AP to perform the sensing measurement on its behalf), performs the sensing measurement, the AP receives the first radio frame sent by the STA, and the time when the AP provides the feedback on the measurement result to the STA is indicated in the first radio frame. That is, in the first radio frame, the time when the requesting STA receives the sensing results is indicated. The first radio frame can be a sensing by proxy (SBP) requesting frame, or the first radio frame can be a message frame configured to negotiate with the AP during an establishment of the sensing measurement.

In some embodiments, the first radio frame includes the first time information. The first time information indicates the timeout time information for the proxy access point (AP) to provide the feedback on the sensing measurement result. The sensing measurement result includes the measurement result of the wireless local area network (WLAN) sensing measurement established by the proxy AP acting as a proxy for the initiator. In some embodiments, the timeout time information can be either a timeout interval element (TIE) or a timeout element. After completing the proxy sensing measurement, the proxy AP will provide the feedback on the sensing measurement result to the requesting STA within the time indicated by the first time information, so as to meet the latency requirements of the requesting STA and improve the WLAN sensing measurement process.

In step 702, a second radio frame is sent, and the second radio frame includes second time information. The second time information indicates time information for the proxy AP to provide the feedback on the sensing measurement result, and a time range indicated by the second time information is within a time range indicated by the first time information.

In some embodiments, the second radio frame can be an SBP response frame. The proxy AP carries, based on the first time information, the second time information in the second radio frame that is replied to the requesting STA. The second time information indicates the time information for the proxy AP to provide the feedback on the sensing measurement result. In some embodiments, the time range indicated by the second time information is within the time range indicated by the first time information. That is, the proxy AP provides the feedback on the sensing measurement result within the time specified by the requesting STA, so as to meet the latency requirements of the requesting STA and improve the WLAN sensing measurement process.

In some embodiments of the present disclosure, the second time information includes at least one of time instant information or time segment information. The time instant information refers to time point information. For example, the proxy AP immediately provides the feedback on the sensing measurement result after receiving the first radio frame. The time segment information refers to time period information. For example, the proxy AP provides the feedback on the sensing measurement result within a time period after receiving the first radio frame.

In some embodiments of the present disclosure, in the absence of a link between the initiator and the proxy AP, the second radio frame further includes time synchronization function (TSF) parameter information of the proxy AP. That is, if the requesting STA does not establish an initial association (i.e., a link) with the proxy AP, the second radio frame further includes the time synchronization function (TSF) parameter information of the proxy AP, so that the requesting STA can keep time synchronization with the proxy AP.

In some embodiments of the present disclosure, the first radio frame includes a sensing by proxy (SBP) requesting frame or a sensing message frame. For example, if the requesting STA participates in the sensing measurement, the requesting STA will carry the first time information in the sensing by proxy (SBP) requesting frame.

If the requesting STA does not participate in the sensing measurement, the requesting STA will carry the first time information in the sensing message frame. The sensing message frame includes a message frame during the establishment of the WLAN sensing measurement by the proxy AP acting as a proxy for the initiator.

In some embodiments of the present disclosure, the proxy AP receives the first radio frame and obtains the first time information carried in the first radio frame, which indicates the timeout time information for the proxy AP to provide the feedback on the sensing measurement result. Embodiments of the present disclosure propose a method for providing the feedback on the measurement result in a scenario where the AP, acting as a proxy for the STA, performs the WLAN sensing measurement.

Based on the same principles as the methods provided in embodiments of the present disclosure, the present disclosure also provides an initiator. The initiator can be a station (STA), as shown in FIG. 8. The station (STA) includes a sending module 801.

The sensing module 801 is configured to send the first radio frame. The first radio frame includes first time information. The first time information indicates timeout time information for a proxy access point (AP) to provide feedback on a sensing measurement result. The sensing measurement result includes a measurement result of a wireless local area network (WLAN) sensing measurement established by the proxy AP acting as a proxy for the initiator.

In some embodiments, the first time information includes latency information for the proxy AP to establish the WLAN sensing measurement, or the timeout time information for the proxy AP to provide the feedback on the sensing measurement result.

In some embodiments, the initiator includes a second receiving module.

The second receiving module is configured to receive a second radio frame. The second radio frame includes second time information, the second time information indicates time information for the proxy AP to provide the feedback on the sensing measurement result, and a time range indicated by the second time information is within a time range indicated by the first time information.

In some embodiments, the second time information includes at least one of time instant information or time segment information.

In some embodiments, in the absence of a link between the initiator and the proxy AP, the second radio frame further includes time synchronization function (TSF) parameter information of the proxy AP.

In some embodiments, the first radio frame includes a sensing by proxy requesting frame or a sensing message frame. The sensing message frame includes a message frame during an establishment of the WLAN sensing measurement by the proxy AP acting as a proxy for the initiator.

In embodiments of the present disclosure, the sending module 801 sends the first radio frame, so as to carry the first time information in the first radio frame, which indicates the timeout time information for the proxy AP to provide the feedback on the sensing measurement result.

Embodiments of the present disclosure also provide a communication apparatus applied to an initiator. The apparatus includes a radio frame sensing module.

The radio frame sensing module is configured to send the first radio frame. The first radio frame includes first time information. The first time information indicates timeout time information for a proxy access point (AP) to provide feedback on a sensing measurement result. The sensing measurement result includes a measurement result of a wireless local area network (WLAN) sensing measurement established by the proxy AP acting as a proxy for the initiator.

The apparatus further includes other modules of the initiator in the aforementioned embodiments, which will not be repeated here.

As shown in FIG. 9, embodiments of the present disclosure also provide an access point (AP). The access point (AP) includes a receiving module 901.

The receiving module 901 is configured to receive a first radio frame. The first radio frame includes first time information, the first time information indicates the timeout time information for the proxy AP to provide feedback on a sensing measurement result, and the sensing measurement result includes a measurement result of a wireless local area network (WLAN) sensing measurement established by the proxy AP acting as a proxy for an initiator.

In some embodiments, the first time information includes latency information for the proxy AP to establish the WLAN sensing measurement, or the timeout time information for the proxy AP to provide the feedback on the sensing measurement result.

In some embodiments, the access point (AP) includes a second sending module.

The second sending module is configured to send a second radio frame, wherein the second radio frame includes second time information, the second time information indicates time information for the proxy AP to provide the feedback on the sensing measurement result, and a time range indicated by the second time information is within a time range indicated by the first time information.

In some embodiments, the second time information includes at least one of time instant information or time segment information.

In some embodiments, in the absence of a link between the initiator and the proxy AP, the second radio frame further includes time synchronization function (TSF) parameter information of the proxy AP.

In some embodiments, the first radio frame includes a sensing by proxy (SBP) requesting frame or a sensing message frame. The sensing message frame includes a message frame during an establishment of the WLAN sensing measurement by the proxy AP acting as a proxy for the initiator.

In embodiments of the present disclosure, the receiving module 901 receives the first radio frame and obtains the first time information carried in the first radio frame, which indicates the timeout time information for the proxy AP to provide the feedback on the sensing measurement result.

Embodiments of the present disclosure also provide a communication apparatus applied to an access point (AP). The apparatus includes a radio frame receiving module.

The radio frame receiving module is configured to receive the first radio frame. The first radio frame includes first time information. The first time information indicates timeout time information for a proxy AP to provide feedback on a sensing measurement result. The sensing measurement result includes a measurement result of a wireless local area network (WLAN) sensing measurement established by the proxy AP acting as a proxy for the initiator.

The apparatus further includes other modules of the access point in the aforementioned embodiments, which will not be repeated here.

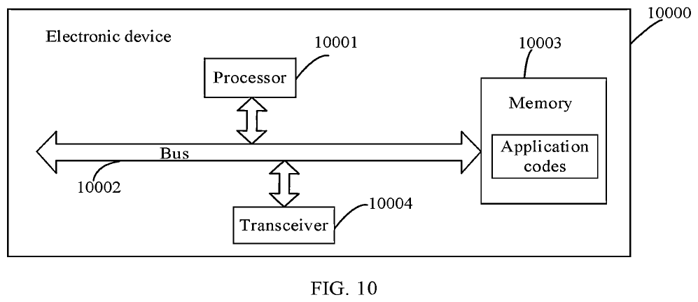

In some embodiments, the present disclosure also provides an electronic device, as shown in FIG. 10. The electronic device 10000 shown in FIG. 10 can be a server, including a processor 10001 and a memory 10003. In some embodiments, the processor 10001 is connected to the memory 10003, for example, through a bus 10002. In some embodiments, the electronic device 10000 can further include a transceiver 10004. It should be noted that in practical applications, the transceiver 10004 is not limited to one transceiver, and a structure of the electronic device 10000 does not constitute a limitation to embodiments of the present disclosure.

The processor 10001 can be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof, which can implement or execute various exemplary logical blocks, modules, and circuits described in conjunction with the present disclosure. The processor 10001 can also be a combination of computing functions, such as a combination containing one or more microprocessors, a combination containing the DSP and the microprocessor, etc.

The bus 10002 can include a path for delivering information between the aforementioned components. The bus 10002 can be a PCI (Peripheral Component Interconnect) bus or an EISA (Extended Industry Standard Architecture) bus, etc. The bus 10002 can be divided into an address bus, a data bus, a control bus, etc. For ease of representation, only one thick line is used in FIG. 10, but it does not mean that there is only one bus or one type of bus.

The memory 10003 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory), or other optical disk storage devices, optical disc storage devices (including compressed discs, laser discs, optical discs, digital universal discs, Blu-ray discs, etc.), magnetic disk storage media or other magnetic storage devices, or any other media that can be used to carry or store desired program codes in the form of instructions or data structures and can be accessed by computers, but not limited to this.

The memory 10003 is used to store application program codes for implementing the present disclosure, and the execution of the codes is controlled by the processor 10001. The processor 10001 is used to execute the application program codes stored in the memory 10003 to implement the methods provided in the aforementioned method embodiments.

In some embodiments, the electronic device includes but is not limited to mobile phones, laptops, digital broadcasting receivers, PDAs (Personal Digital Assistant), PADs (tablet), PMPs (Portable Multimedia Player), in-vehicle terminals (such as in-vehicle navigation terminals), and fixed terminals such as digital TVs, desktop computers, and so on. The electronic device shown in FIG. 10 is only an example and should not impose any limitations on the functionality and the use scope of embodiments of the present disclosure.

The server provided in the present disclosure can be an independent physical server, a server cluster or a distributed system composed of multiple physical servers, or a cloud server that provides basic cloud computing services such as cloud service, cloud database, cloud computing, cloud function, cloud storage, network service, cloud communication, middleware service, domain name service, security service, CDN, as well as big data and artificial intelligence platform. The terminal can be smartphone, tablet, laptop, desktop computer, smart speaker, smartwatch, etc., but is not limited to this. The terminal and the server can be directly or indirectly connected through wired or wireless communication methods, and the present disclosure is not limited here.

Embodiments of the present disclosure provide a computer-readable storage medium on which a computer program is stored. When the computer program is running on a computer, enables the computer to implement the corresponding content of the aforementioned method embodiments.

It should be understood that although the various steps in the flowchart in the drawings are displayed in sequence indicated by arrows, these steps are not necessarily executed in the order indicated by the arrows. Unless explicitly stated in the article, the execution of these steps does not have strict order restrictions and can be carried out in other orders. Moreover, at least a portion of the steps in the flowchart of the drawings can include multiple sub steps or stages, which may not necessarily be completed at the same time, but may be executed at different times, and their execution order may not necessarily be in sequence, but may rotate or alternate with at least a portion of other steps or sub steps or stages.

It should be noted that the computer-readable medium mentioned in the present disclosure can be a computer-readable signal medium, a computer-readable storage medium, or any combination of the two. The computer-readable storage medium can be, but is not limited to, an electrical, magnetic, optical, electromagnetic, infrared, or semiconductor system, apparatus, or device, or any combination thereof. More specific examples of the computer-readable storage medium can include, but are not limited to: electrical connections with one or more wires, portable computer disks, hard drives, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In the present disclosure, a computer-readable storage medium can be any tangible medium containing or storing a program, which can be used by an instruction execution system, apparatus, or device, or in combination with it. In the present disclosure, the computer-readable signal medium can include data signals propagated in the baseband or as part of the carrier wave, which carry computer-readable program codes. This type of transmitted data signal can take various forms, including but not limited to electromagnetic signals, optical signals, or any suitable combination of the above. The computer-readable signal medium can also be any computer-readable medium other than a computer-readable storage medium, which can send, propagate, or transmit programs for use by an instruction execution system, apparatus, or device, or in combination with it. The program code contained on computer-readable medium can be transmitted using any appropriate medium, including but not limited to: wires, optical cables, RF (radio frequency), etc., or any suitable combination of the above.

The above-mentioned computer-readable medium can be included in the electronic device mentioned above. It can also exist separately without being assembled into the electronic device.

The above-mentioned computer-readable medium carries one or more programs, which, when executed by the electronic device, cause the electronic device to implement the methods shown in the above embodiments.

According to one aspect of the present disclosure, a computer program product or computer program is provided, including computer instructions stored in a computer-readable storage medium. The processor of a computer device reads the computer instruction from the computer-readable storage medium, executes the computer instructions, and causes the computer device to implement the communication methods provided in the various embodiments mentioned above.

The computer program codes for implementing the operations disclosed herein can be written in one or more programming languages or combinations thereof, including object-oriented programming languages such as Java, Smalltalk, C++, and conventional procedural programming languages such as C or similar programming languages. The program codes can be completely executed on the user's computer, partially executed on the user's computer, executed as an independent software package, partially executed on the user's computer and partially executed on a remote computer, or completely executed on the remote computer or a server. In the case where remote computers are involved, the remote computer can be connected to the user computer through any type of networks, including local area networks (LAN) or wide area networks (WAN), or can be connected to an external computer (such as connected via the internet provided by internet service providers).

The flowchart and block diagram in the drawings illustrate the possible architectures, functions, and operations of the systems, methods, and computer program products according to various embodiments of the present disclosure. Each box in a flowchart or block diagram can represent a module, a program segment, or a part of codes that contain one or more executable instructions for implementing a specified logical function. It should also be noted that in some embodiments, the functions indicated in the box can also occur in a different order than those indicated in the drawings. For example, two consecutive boxes can actually be executed in basic parallel order, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions.

The modules described in embodiments of the present disclosure can be implemented through software or hardware. In some embodiments, the name of the module does not constitute a limitation on the module itself in a certain situation. For example, module A can also be described as “module A used to perform operation B”.

The above description is only for embodiments of the present disclosure and an explanation of the technical principles involved. Those skilled in the art should understand that the scope of the present disclosure is not limited to technical solutions formed by specific combinations of the technical features mentioned above, and should also cover other technical solutions formed by arbitrary combinations of the technical features mentioned above or their equivalent features without departing from the concept disclosed. For example, a technical solution formed by replacing the above features with technical features with similar functions disclosed (but not limited to) in the present disclosure.

1. A communication method, performed by an initiator, the method comprising:
sending a first radio frame, wherein the first radio frame comprises first time information, the first time information indicates timeout time information for a proxy access point (AP) to provide feedback on a sensing measurement result, and the sensing measurement result comprises a measurement result of a wireless local area network (WLAN) sensing measurement established by the proxy AP acting as a proxy for the initiator.

2. The communication method according to claim 1, wherein the first time information comprises latency information for the proxy AP to establish the WLAN sensing measurement, or the timeout time information for the proxy AP to provide the feedback on the sensing measurement result.

3. The communication method according to claim 1, further comprising:
receiving a second radio frame, wherein the second radio frame comprises second time information, the second time information indicates time information for the proxy AP to provide the feedback on the sensing measurement result, and a time range indicated by the second time information is within a time range indicated by the first time information.

4. The communication method according to claim 3, wherein the second time information comprises at least one of time instant information or time segment information.

5. The communication method according to claim 3, wherein in the absence of a link between the initiator and the proxy AP, the second radio frame further comprises time synchronization function (TSF) parameter information of the proxy AP.

6. The communication method according to claim 1, wherein the first radio frame comprises a sensing by proxy (SBP) requesting frame or a sensing message frame, and wherein the sensing message frame comprises a message frame during an establishment of the WLAN sensing measurement by the proxy AP acting as a proxy for the initiator.

7. A communication method, performed by a proxy access point (AP), the method comprising:
receiving a first radio frame, wherein the first radio frame comprises first time information, the first time information indicates the timeout time information for the proxy AP to provide feedback on a sensing measurement result, and the sensing measurement result comprises a measurement result of a wireless local area network (WLAN) sensing measurement established by the proxy AP acting as a proxy for an initiator.

8. The communication method according to claim 7, wherein the first time information comprises latency information for the proxy AP to establish the WLAN sensing measurement, or the timeout time information for the proxy AP to provide the feedback on the sensing measurement result.

9. The communication method according to claim 7, further comprising:
sending a second radio frame, wherein the second radio frame comprises second time information, the second time information indicates time information for the proxy AP to provide the feedback on the sensing measurement result, and a time range indicated by_the second time information is within a time range indicated by the first time information.

10. The communication method according to claim 9, wherein the second time information comprises at least one of time instant information or time segment information.

11. The communication method according to claim 9, wherein in the absence of a link between the initiator and the proxy AP, the second radio frame further comprises time synchronization function (TSF) parameter information of the proxy AP.

12. The communication method according to claim 7, wherein the first radio frame comprises a sensing by proxy (SBP) requesting frame or a sensing message frame, and wherein the sensing message frame comprises a message frame during an establishment of the WLAN sensing measurement by the proxy AP acting as a proxy for the initiator.

13-16. (canceled)

17. An initiator comprising:
a processor; and
a memory storing instructions executable by the processor,
wherein the processor is configured to:
send a first radio frame, wherein the first radio frame comprises first time information, the first time information indicates timeout time information for a proxy access point (AP) to provide feedback on a sensing measurement result, and the sensing measurement result comprises a measurement result of a wireless local area network (WLAN) sensing measurement established by the proxy AP acting as a proxy for the initiator.

18. A non-transitory computer-readable storage medium having instructions stored thereon, which when executed by a processor, cause the processor to execute the method according to claim 1.

19. A proxy access point (AP) comprising:
a processor; and
a memory storing instructions executable by the processor,
wherein the processor is configured to execute the instructions to implement the method according to claim 7.

20. A non-transitory computer-readable storage medium having instructions stored thereon, which when executed by a processor, cause the processor to execute the method according to claim 7.
